(19) United States
(12) Patent Application Publication
(10) Pub. No.: US 2013/0171480 A1
(43) Pub. Date: Jul. 4, 2013

(54) System and Method for Monitoring Battery Bus Bars Within a Battery Pack

(71) Applicants: Kirk Englert, Dearborn, MI (US); Brian D. Rutkowski, Ypsilanti, MI (US)

(72) Inventors: Kirk Englert, Dearborn, MI (US); Brian D. Rutkowski, Ypsilanti, MI (US)

(73) Assignee: A123 SYSTEMS, INC., Waltham, MA (US)

(21) Appl. No.: 13/701,777

(22) PCT Filed: May 26, 2011
(86) PCT No.: PCT/US11/38073

§ 371 Date: Dec. 13, 2012

Related U.S. Application Data
(60) Provisional application No. 61/351,004, filed on Jun. 3, 2010.

(51) Int. Cl. H01M 10/48

(52) U.S. Cl. CPC H01M 10/486
USPC 429/50; 429/90; 429/61

(57) ABSTRACT

Systems and methods monitoring battery bus bars are disclosed. In one example, positive temperature coefficient thermistors are coupled to battery bus bars. The systems and method may reduce the cost and complexity of battery bus bar monitoring.

### TECHNICAL FIELD

The present description relates to monitoring battery bus bars of a battery pack supplying power to a vehicle.

### BACKGROUND AND SUMMARY

Many hybrid and electric vehicles receive at least a portion of motive power from batteries. The batteries may be comprised of battery cells that are combined in series and parallel to provide power to an electric motor that propels the vehicle. Further, batteries may be configured with bus bars to transfer charge within a battery pack. Bus bar degradation may reduce the current capacity or voltage of a battery pack. As such, various approaches may be used to monitor performance of a battery bus bar.

The inventors herein have recognized that battery bus bars can be monitored with temperature sensors, while at the same time the position and configuration of the temperature sensors can be strategically selected to reduce system cost and complexity. As such, the inventors herein have developed a method for monitoring status of battery bus bars, comprising: coupling a plurality of temperature sensors to a plurality of battery bus bars; electrically coupling said plurality of temperature sensors in a daisy-chain configuration; and adjusting battery pack operation in response to a change in state of output of said daisy-chain configuration.

By electrically coupling temperature sensors in a daisy-chain configuration, the state of electrical bus bars can be monitored at less expense and complexity. For example, instead of the number of controller inputs for monitoring battery bus bars equaling the number of battery bus bars, the number of controller inputs may be reduced, and in some cases reduced to only a single input. Further, the present approach includes adjusting battery pack operation in response to a change in state of daisy-changed temperature sensors. Therefore, the present approach may be useful for adjusting battery pack operation to limit further degradation within the battery pack.

The present description may provide several advantages. For example, the approach may reduce the cost of monitoring battery bus bars. In addition, the present approach may reduce a number of electrical connections and inputs to a controller for monitoring battery bus bars.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an exploded schematic view of a battery pack or assembly;

FIG. 2 shows a schematic view of an exemplary battery module;

FIG. 3 shows an exploded schematic view of an exemplary battery cell stack;

FIG. 4 shows a schematic view of a system for monitoring electrical current carrying battery bus bars;

FIG. 5 shows a schematic view of a system for monitoring electrical current carrying battery bus bars;

FIG. 6 shows a transfer function of a representative temperature sensor for reducing a number of electrical connections for monitoring electrical current carrying battery bus bar temperatures; and

FIG. 7 shows a flow chart illustrating a method for monitoring electrical current carrying battery bus bars.

### DETAILED DESCRIPTION OF THE DEPICTED EMBODIMENTS

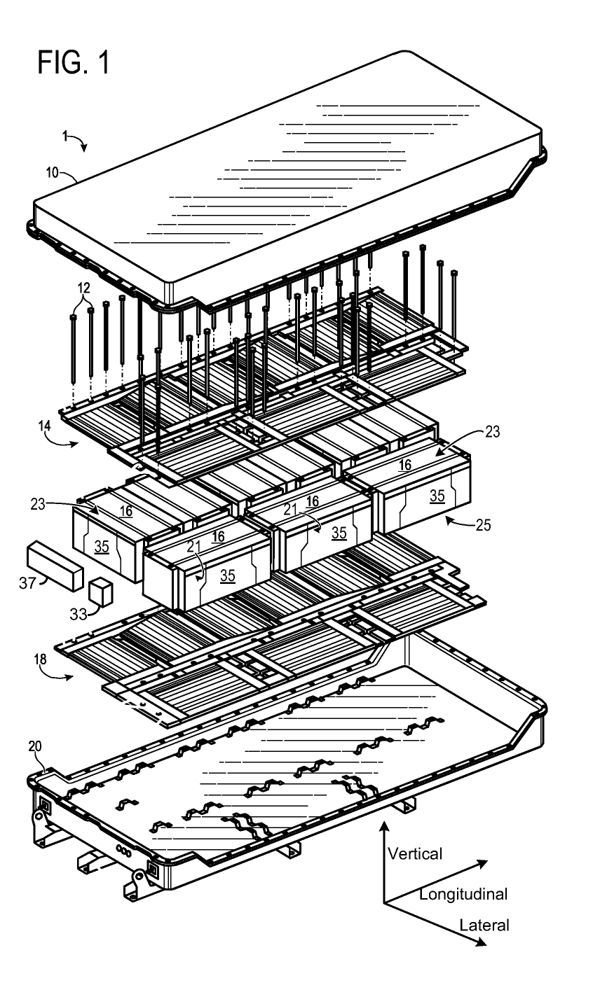

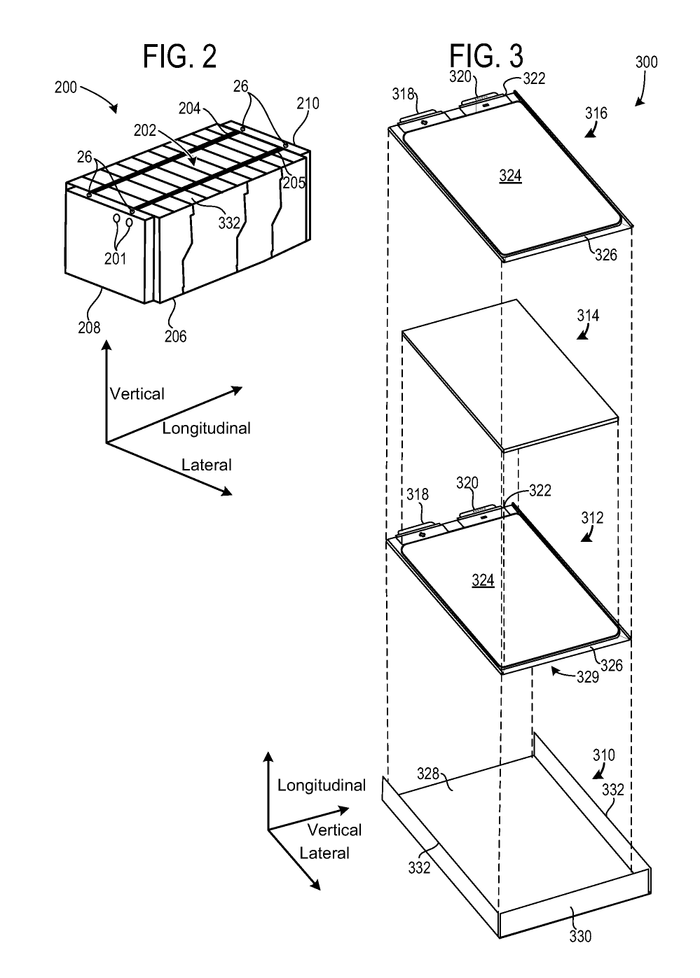

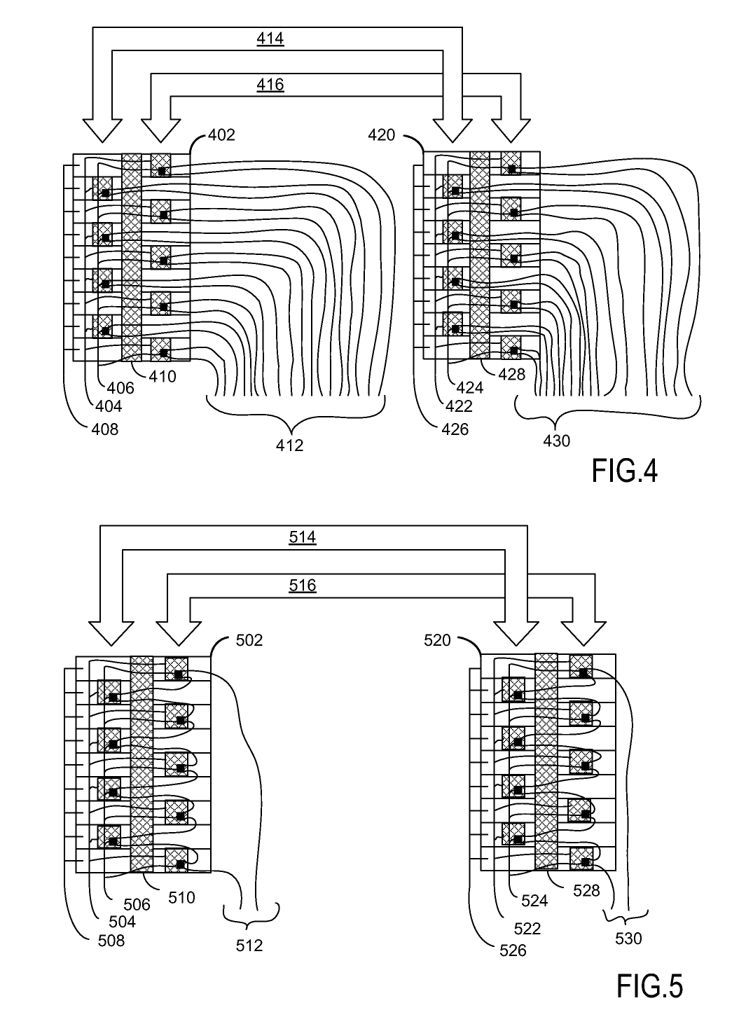

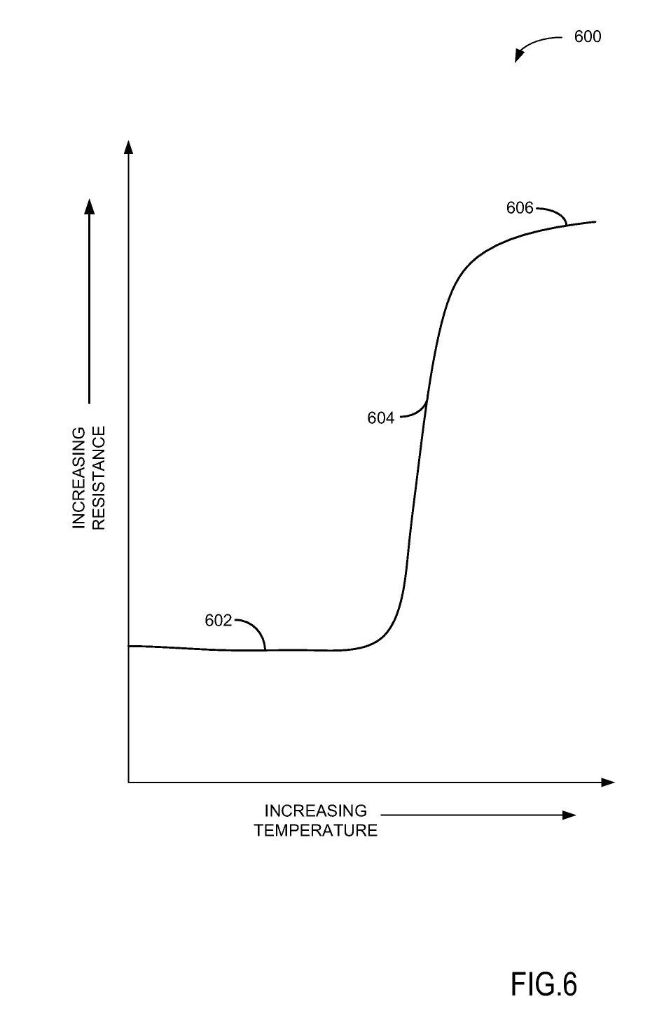

The present description is related to monitoring electrical current carrying battery bus bars of a battery that may supply power to propel a vehicle. In one embodiment, battery cells such as those illustrated in FIGS. 2-3 may be combined in a battery pack as illustrated in FIG. 1. FIG. 4 illustrates one example of a system for monitoring electrical current carrying battery bus bars while FIG. 5 describes an alternative electrical current carrying battery bus bar monitoring system that has advantages that are not available with the system described in FIG. 4. FIG. 6 describes an example method for improving monitoring electrical current carrying battery bus bars.

Electrical current carrying battery bus bars are used to route charge from one battery cell to other battery cells. In this way, the charge of battery cells may be combined to increase the available voltage and current of a battery pack. The temperature of electrical current carrying battery bus bars may be used as an indication of the performance or status of electrical current carrying battery bus bars. For example, if the condition of an electrical current carrying battery bus bar degrades, the temperature of the battery bus bar can increase. Therefore, it may be desirable to monitor the temperatures of battery bus bars so that mitigating actions may be taken if it is determined that battery bus bar degradation is present. The present description provides for a simplified cost effective system and method for monitoring battery bus bars.

FIG. 1 shows an exploded view of a battery assembly 1. The battery assembly may include a cover 10, coupling devices 12, a first cooling subsystem 14 (e.g., cold plate), a plurality of battery modules 16, a second cooling subsystem 18 (e.g., cold plate), and a tray 20. The cover may be attached to the tray via a suitable coupling device (e.g., bolts, adhesive, etc.,) to form a housing surrounding the coupling devices, the cooling subsystems, and the battery modules, when assembled.

The battery modules 16 may include a plurality of battery cells configured to store energy. Although a plurality of battery modules are illustrated, it will be appreciated that in other examples a single battery module may be utilized. Battery modules 16 may be interposed between the first cooling subsystem 14 and the second cooling subsystem 18, where the battery modules are positioned with their electrical terminals on a side 21 facing out between the cooling subsystems.

Each battery module may include a first side 23 and a second side 25. The first and the second side may be referred to as the top and bottom side, respectively. The top and bottom sides may flank the electrical terminals, discussed in greater detail herein with regard to FIGS. 2-3. In this example, the top side of each battery module is positioned in a common plane in the battery assembly. Likewise, the bottom side of each battery module is positioned in another common plane in the battery assembly. However, in other examples only the top side or the bottom side of each battery module may be positioned in a common plane. In this way, the cooling subsystems may maintain direct contact with the top sides and the bottom sides of the battery modules to increase heat transfer and improve cooling capacity, as described in further detail herein, wherein the cooling subsystems and the battery modules may be in face-sharing contact. Additional details of an exemplary battery module are described herein with regard to FIGS. 2-3. In alternate examples, only one of the cooling subsystems may be included in battery assembly 1, such as an upper cooling subsystem (subsystem 14 in this example). Moreover, the position, size, and geometry of the first and second cooling subsystems are exemplary in nature. Thus, the position, size, and/or geometry of the first and/or second cooling subsystems may be altered in other examples based on various design parameters of the battery assembly.

Battery assembly 1 may also include an electrical distribution module 33 (EDM), monitor and balance boards 35 (MBB), and a battery control module 37 (BCM). Voltage of battery cells in battery modules 16 may be monitored and balanced by MBBs that are integrated onto battery modules 16. Balancing battery cells refers to equalizing charge between a plurality of battery cells in a battery cell stack. Further, battery cell voltages between battery cell stacks can be equalized. MBBs may include a plurality of current, voltage, and other sensors. The EDM controls the distribution of power from the battery pack to the battery load. In particular, the EDM contains contactors for coupling high voltage battery power to an external battery load such as an inverter. The BCM provides supervisory control over battery pack systems. For example, the BCM may control ancillary modules within the battery pack such as the EDM and cell MBB, for example. Further, the BCM may be comprised of a microprocessor having random access memory, read only memory, input ports, real time clock, output ports, and a computer area network (CAN) port for communicating to systems outside of the battery pack as well as to MBBs and other battery pack modules.

FIG. 2 shows an exemplary battery module 200 that may be included in the plurality of battery modules 16, shown in FIG. 1. Battery module 200 may include a battery cell stack having a plurality of stacked battery cells and output terminals 201. The stacked arrangement allows the battery cells to be densely packed in the battery module.

FIG. 3 shows an exploded view of a portion of an exemplary battery cell stack 300. As shown the battery cell stack is built in the order of a housing heat sink 310, battery cell 312, compliant pad 314, battery cell 316, and so on. However, it will be appreciated that other arrangement are possible. For example, the battery cell stack may be built in the order of a housing heat sink, battery cell, housing heat sink, etc. Further in some examples, the housing heat sink may be integrated into the battery cells.

Battery cell 312 includes cathode 318 and anode 320 for connecting to a bus bar (not shown). The bus bar routes charge from one batter cell to another. A battery module may be configured with battery cells that are coupled in series and/or parallel. Bus bars couple like battery cell terminals when the battery cells are combined in parallel. For example, the positive terminal of a first battery cell is coupled to the positive terminal of a second battery cell to combine the battery cells in parallel. Bus bars also couple positive and negative terminal of battery cell terminals when it is desirable to increase the voltage of a battery module. Battery cell 312 further includes prismatic cell 324 that contains electrolytic compounds. Prismatic cell 324 is in thermal communication with cell heat sink 326. Cell heat sink 326 may be formed of a metal plate with the edges bent up 90 degrees on one or more sides to form a flanged edge. In the example of FIG. 3, two opposing sides include a flanged edge. However, other geometries are possible. Battery cell 312 is substantially identical to battery cell 316. Therefore similar parts are labeled accordingly. Battery cells 312 and 316 are arranged with their terminals in alignment and exposed. In battery module 200 shown in FIG. 2 the electric terminals are coupled to enable energy to be extracted from each cell in the battery module. Returning to FIG. 3, compliant pad 314 is interposed between battery cell 312 and battery cell 316. However, in other examples the compliant pad may not be included in the battery cell stack.

Housing heat sink 310 may be formed by a metal plate having a base 328 with the edges bent up 90 degrees on one or more sides to form a flanged edge. In FIG. 3 longitudinally aligned edge 330 and vertically aligned edges 332 are bent flanged edges. As depicted, the housing heat sink is sized to receive one or more battery cells. In other words, one or more battery cells may be positioned within base 328. Thus, the flanged edges of the battery cells may be in contact with housing heat sink and underside 329 of battery cell 312 may be in contact with the base of the housing heat sink, facilitating heat transfer.

One of the longitudinally aligned edges 332 of the housing heat sink 310 may form a portion of the top side 202 of battery module 200, as shown in FIG. 2. Similarly, one of the longitudinally aligned edges 332 may form a portion of the bottom side of the battery module. Thus, the longitudinally aligned edges of the housing heat sink may be in contact with the first and the second cooling subsystems to improve heat transfer. In this way, heat may be transferred from the battery cells to the exterior of the battery module.

The battery cells may be strapped together by binding bands 204 and 205. The binding bands may be wrapped around the battery cell stack or may simply extend from the front of the battery cell stack to the back of the battery cell stack. In the latter example, the binding bands may be coupled to a battery cover. In other embodiments, the binding bands may be comprised of threaded studs (e.g., metal threaded studs) that are bolted at the ends. Further, various other approaches may be used to bind the cells together into the stack. For example, threaded rods connected to end plates may be used to provide the desired compression. In another example, the cells may be stacked in a rigid frame with a plate on one end that could slide back and forth against the cells to provide the desired compressive force. In yet other embodiments, rods held in place by cotter pins may be used to secure the battery cells in place. Thus, it should be understood that various binding mechanisms may be used to hold the cell stack together, and the application is not limited to metal or plastic bands. Cover 206 provides protection for battery bus bars (not shown) that route charge from the plurality of battery cells to output terminals of the battery module.

The battery module may also include a front end cover 208 and a rear end cover 210 coupled to the battery cell stack. The front and rear end covers include module openings 26. However, in other examples the module openings may be included in a portion of the battery module containing battery cells.

Referring now to FIG. 4, a schematic view of an arrangement for monitoring battery bus bars is shown. Battery modules 402 and 420 are in electrical communication by way of current conducting straps 414 and 416. Bus bars 404 are shown linking battery cells 408 while bus bar 410 brings forth the potential of one side of the lowest potential battery cell for linking battery cell stacks together by conducting straps. Bus bars 404 are shown alternating in a left side, right side, left side arrangement. This arrangement enables the battery cells to be flipped back and forth such that cathodes and anodes of battery cells alternate from the left and right side of the battery cell stack. Temperature sensing devices 406 (e.g., thermistors or thermocouples) are shown coupled to bus bars 404. Likewise, battery cells 426, temperature sensing devices 424, bus bars 422, and bus bar 428 are similarly shown arranged with battery module 420.

Temperature sensing devices 406 and 424 are shown each having two wiring leads extending to wiring bundles 412 and 430. Thus, the number of wiring leads is two times the number of temperature sensing devices. The wiring arrangement shown in FIG. 4 allows the temperature of each bus bar to be determined. However, the wiring arrangement of FIG. 4 requires a monitoring input for each temperature sensing device. Further, each wire from each temperature sensing device requires termination and routing to an analog input of a MBB. Consequently, this wiring arrangement may increase system cost and complexity.

Referring now to FIG. 5, a schematic view of a system for monitoring a battery bus bars is shown. Battery cells 508 and 526, bus bars 504 and 522, bus bars 510 and 528, and conducting straps 514 and 516 are shown identical as those shown in FIG. 4. FIG. 5 also shows temperature sensing devices 506 and 524 arranged similar to temperature sensing devices shown in FIG. 4. However, FIG. 5 shows temperature sensing devices 506 and 524 wired in a daisy-chain arrangement. In one example, a first temperature sensor is wired to a second temperature sensor and the second temperature sensor is wired to a third temperature sensor and so on. As shown in FIG. 5 at 512 and 530, one wire of a first temperature sensor is an input for monitoring bus bar temperatures of a plurality of bus bars 504. A second wire of the first temperature sensor is coupled to a first wire of a second temperature sensor, and a second wire of the second temperature sensor is coupled to a third temperature sensor. This wiring arrangement continues in battery modules 502 and 520 to temperature sensors coupled to the last battery cells where the second wire of the temperature sensors becomes part of wiring bundles 512 and 530. Thus, the temperatures of a plurality of bus bars of a battery module may be monitored with a single set of wires.

In one example, the temperature sensor may be of a type that has a transfer function as illustrated in FIG. 6. A series of temperature sensors having a high gain or change in output in a predetermined temperature range can be daisy-chained together so that whenever one temperature sensor is exposed to a temperature that is at or above the predetermined temperature, the output of the chain of temperature sensors effectively changes state to a higher impedance state, for example. Although monitoring of bus bar temperatures with daisy-chained temperature sensors does not allow a controller to isolate a temperature of a specific battery cell, it does reduce the number of wires, wire connections, and controller inputs for determining if an electrical power bus bar temperature of a battery module exceeds a threshold temperature. Thus, the wiring configuration shown in FIG. 5 has several advantages over the wiring configuration of FIG. 4.

In addition, the temperature sensors may be coupled to different locations on each bus bar of a plurality of bus bars. For example, for two identical bus bars, a first temperature sensor may be coupled to a first end of a first bus bar while a second temperature sensor may be coupled to a second end of a second bus bar, the second end of the second bus bar different from the first end of the first bus bar. By coupling temperature sensors at different positions of different bus bars it is possible to locate temperature sensors at bus bar positions that may be more prone to indicate bus bar degradation related to battery module configuration.

Thus, the system of FIG. 5 provides for a system for monitoring battery bus bars, comprising: a plurality of battery cells comprising a battery module; a plurality of battery bus bars electrically coupling said plurality of battery cells; and a plurality of temperature sensors electrically coupled in a daisy-chain configuration and mechanically coupled to the plurality of bus bars. The system may also further comprise a controller, the controller including instructions for adjusting operation of a battery pack in response to a change in state of said daisy-chain configuration. The system can also include where the daisy-chain configuration comprises electrically coupling a wiring lead of a first temperature sensor to a first wiring lead of a second temperature sensor and coupling a second wiring lead of said second temperature sensor to a wiring lead of a third temperature sensor, where the first temperature sensor is coupled to the bus bar adjacent a first cell, and the second temperature sensor is coupled to the bus bar adjacent a second cell. The system may incorporate a plurality of positive temperature coefficient temperature sensors. The system may also include lithium-ion battery cells. Further, the system can be configured such that a plurality of temperature sensors are input to a single digital input of a controller.

Referring now to FIG. 6, a transfer function 600 of a representative temperature sensor for reducing a number of electrical connections for monitoring battery bus bar temperatures is shown. The transfer function plot shows an X axis that represents temperature. Temperature increases from the left to the right. The transfer function plot shows a Y axis that represents sensor resistance. Sensor temperature resistance increases from the bottom of the plot to the top of the plot. At temperatures less than a threshold temperature, the temperature sensor resistance is in a first region 602 where the sensor resistance is at a first level and increases with increasing temperature at a first rate, above the threshold temperature, the temperature sensor output (e.g. resistance) increases at a second rate as shown at 604, the second rate greater than the first rate. In a third region 606, the temperature sensor resistance remains higher than in the first region 602, but the rate of change in the temperature sensor resistance is reduced to a level less than the second rate. Thus, the temperature sensor resistance provides switch like behavior increasing sensor resistance from a first state to a second state after the temperature sensor is exposed to temperatures greater than a threshold temperature. The switch like temperature sensor behavior shown in FIG. 6 may be used in a system as shown in FIG. 5 to monitor the state of electrical current carrying bus bars. In particular, if the resistance of a plurality of temperature sensors arranged in a daisy-chain configuration indicates a high level of resistance, it may be determined that the temperature of at least one electrical current carrying bus bar is above a desired level.

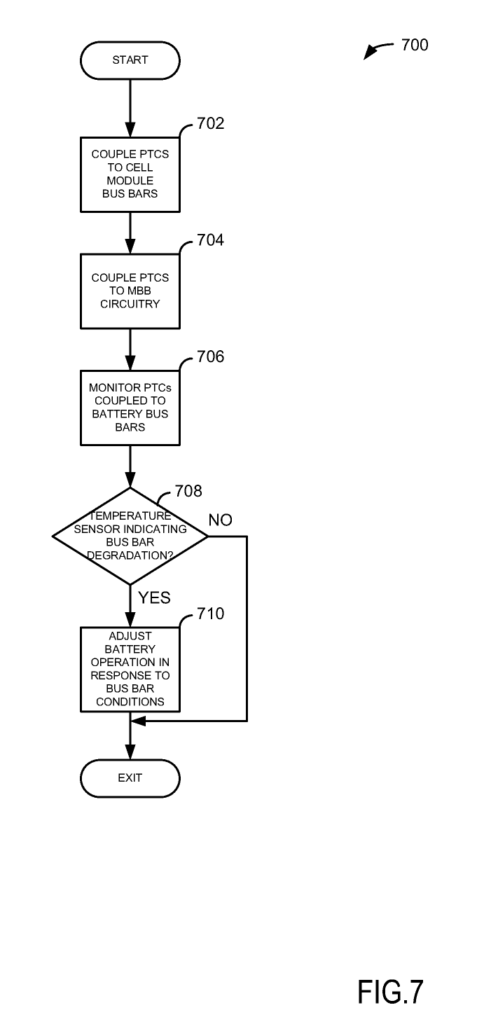

Referring now to FIG. 7, a flow chart illustrating a method of monitoring electrical current carrying battery bus bars is shown. Routine 700 starts at 702 where positive temperature coefficient temperature sensors are coupled to battery module electrical current carrying bus bars. However, it should be mentioned that negative temperature coefficient temperature sensors may also be coupled to electrical current carrying bus bars if desired. In one example, the battery bus bars may be used to couple battery cells in parallel or series configurations. In one example, temperature sensors are coupled in a daisy-chain configuration as shown in FIG. 5. If the temperature of one battery cell exceeds a threshold temperature, the output of the plurality of daisy-chained temperature sensors changes state. For example, if the temperatures of seven battery bus bars are monitored with seven temperature sensors and the temperature of one bus bar exceeds a threshold temperature, the output of the daisy-chained seven sensors changes state from a low resistance to a higher resistance.

At 704, routine 700 couples a plurality of daisy-chained temperature sensors that are coupled to a plurality of batter bus bars to circuitry for monitoring. In one example, the daisy-chained sensors are coupled to a voltage divider network so that when the resistance of one of the temperature sensors responds to a bus bar temperature greater than a threshold temperature, the voltage output of the divider network changes. In another example, the resistance of the daisy-chained sensors coupled to a plurality of battery bus bars may be monitored to determine whether or not a temperature of a battery bus bar exceeds a threshold temperature.

At 706, routine 700 monitors the plurality of daisy-chained temperature sensors that are coupled to a plurality of battery bus bars. In one example, the PTCs may be monitored by way of an analog-to-digital converter. In another example, a digital input may be used to monitor the PTC's. For example, if the resistance of a daisy-chained group of temperature sensors changes in response to a temperature of a battery buss bar exceeding a threshold temperature, a digital input to a controller may change from a zero level to a one level. Further, a plurality of temperature sensors from a plurality of battery modules may be in electrical communication with a digital input of a controller such that any one degraded battery cell from a plurality of battery modules may indicate battery bus bar degradation. In one particular example, one particular signal monitored by the controller may be responsive to each of a plurality of temperature sensors, such that if any one of the temperature sensors indicates degradation, the signal received by the controller indicates degradation. Conversely, only if each and every temperature sensor in the circuit indicates that the temperatures are within acceptable limits, does the signal not indicate degradation.

At 708, routine judges whether or not a temperature sensor indicates bus bar degradation. In one example, if an input to a controller is greater than a threshold level, it may be determined that bus bar degradation is present. In other examples, it may be determined that bus bar degradation is present when an input to a controller is less than a threshold level. If routine 700 judges a temperature sensor is indicating bus bar degradation, routine 700 proceeds to 710. Otherwise, routine 700 proceeds to exit.

At 710, routine adjusts battery operation in response to bus bar conditions indicated by temperature sensors that are in a daisy-chain configuration. In one example, a battery controller may reduce the output of a battery in response to indication of bus bar degradation. For example, a battery controller may limit the battery pack current output. In another example, the battery controller may send a status message to a vehicle controller so that the vehicle controller limits and/or reduces an amount of torque from a motor of a vehicle. Further, the battery pack controller can send out a status message so that a current level of some vehicle systems is maintain and so that current supplied to other vehicle systems is reduced. In this way, the overall demand current on the battery pack may be reduced. Further still, the battery pack may issue a battery degradation message so that the vehicle controller may limit the current demands of vehicle systems to some predetermined amount. For example, if the battery pack sends a degradation command, the vehicle controller may limit current to the vehicle propulsion motor to 60% of full current. Further, the vehicle controller may limit accessory (e.g., air conditioner current) to 20% of full current. In some embodiments, the battery controller status message may send a status message that defines the amount of available current to the vehicle so that the vehicle controller can set priorities as to what vehicle systems receive battery current. Further, the vehicle controller may set current limits to different vehicle systems based on the status message sent from the battery controller. Routine 700 then proceeds to exit.

Thus, the method of FIG. 7 provides for a method for monitoring status of battery bus bars, comprising: adjusting battery pack operation in response to a change in state of output of any of a plurality of temperatures sensors coupled at different locations to one or more bus bars, the plurality of temperature sensors in a daisy-chain configuration. The method may include a daisy-chain configuration comprising a wiring lead of a first temperature sensor electrically coupled to a first wiring lead of a second temperature sensor and a second wiring lead of said second temperature sensor electrically coupled to a wiring lead of a third temperature sensor. Further, the method may include temperature sensors that are positive temperature coefficient sensors. The method can also adjust the battery pack operation such that the output of the battery pack is reduced. Further, the method can adjust battery pack operation by sending a status message so that an external load limits current drawn from said battery pack. The method is applicable for a plurality of bus bars coupled to a single battery module. The method also applies for a battery module that is one of a plurality of battery modules included in a battery pack. The method is also applicable where a plurality of battery bus bars are electrically coupled to a plurality of lithium-ion battery cells.

The method of FIG. 7 also provides a method for monitoring status of battery bus bars, comprising: coupling a plurality of temperature sensors to a plurality of battery bus bars; electrically coupling said plurality of temperature sensors in a daisy-chain configuration; electrically coupling said plurality of temperature sensors to a digital input of a controller; and adjusting battery pack operation in response to a change in state of said digital input. The method applies to a plurality of temperature sensors that are coupled to said plurality of bus bars of a battery module. The method also applies to a battery module that is one battery module of a plurality of battery modules of a battery pack. The method includes where the daisy-chain configuration comprises electrically coupling a wiring lead of a first temperature sensor to a first wiring lead of a second temperature sensor and coupling a second wiring lead of said second temperature sensor to a wiring lead of a third temperature sensor. The method includes where adjusting battery pack operation includes reducing output of a battery pack. And, the method includes where adjusting battery pack operation includes sending a status message so that an external load limits current drawn from said battery pack.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for monitoring status of battery bus bars, comprising:
adjusting battery pack operation in response to a change in state of output of any of a plurality of temperatures sensors mechanically coupled at different locations to one or more battery bus bars, the plurality of temperature sensors in a daisy-chain configuration.

2. The method of claim 1, where said daisy-chain configuration comprises a wiring lead of a first temperature sensor electrically coupled to a first wiring lead of a second temperature sensor and a second wiring lead of said second temperature sensor electrically coupled to a wiring lead of a third temperature sensor.

3. The method of claim 1, where said temperature sensors are positive temperature coefficient sensors.

4. The method of claim 1, where adjusting battery pack operation includes reducing output of a battery pack.

5. The method of claim 1, where adjusting battery pack operation includes sending a status message so that an external load limits current drawn from said battery pack.

6. The method of claim 1, where said plurality of bus bars are coupled to a single battery module.

7. The method of claim 6, where said battery module is one of a plurality of battery modules included in a battery pack.

8. The method of claim 1, where said plurality of battery bus bars are electrically coupled to lithium-ion battery cells.

9. A method for monitoring status of battery bus bars, comprising:
coupling a plurality of temperature sensors to a plurality of battery bus bars;
electrically coupling said plurality of temperature sensors in a daisy-chain configuration;
electrically coupling said plurality of temperature sensors to a digital input of a controller; and
adjusting battery pack operation in response to a change in state of said digital input.

10. The method of claim 9, where said plurality of temperature sensors are coupled to said plurality of bus bars of a battery module.

11. The method of claim 10, where said battery module is one battery module of a plurality of battery modules of a battery pack.

12. The method of claim 9, where said daisy-chain configuration comprises electrically coupling a wiring lead of a first temperature sensor to a first wiring lead of a second temperature sensor and coupling a second wiring lead of said second temperature sensor to a wiring lead of a third temperature sensor.

13. The method of claim 9, where adjusting battery pack operation includes reducing output of a battery pack.

14. The method of claim 9, where adjusting battery pack operation includes sending a status message so that an external load limits current drawn from said battery pack.

15. A system for monitoring battery bus bars, comprising:
a plurality of battery cells comprising a battery module;
a plurality of battery bus bars electrically coupling said plurality of battery cells; and
a plurality of temperature sensors electrically coupled in a daisy-chain configuration and mechanically coupled to the plurality of bus bars.

16. The system of claim 15, further comprising a controller, said controller including instructions for adjusting operation of a battery pack in response to a change in state of said daisy-chain configuration.

17. The system of claim 15, where said daisy-chain configuration comprises electrically coupling a wiring lead of a first temperature sensor to a first wiring lead of a second temperature sensor and coupling a second wiring lead of said second temperature sensor to a wiring lead of a third temperature sensor, where the first temperature sensor is coupled to the bus bar adjacent a first cell, and the second temperature sensor is coupled to the bus bar adjacent a second cell.

18. The system of claim 17, where said plurality of temperature sensors are positive temperature coefficient sensors.

19. The system of claim 15, where said battery cells are lithium-ion battery cells.

20. The system of claim 16, where said plurality of temperature sensors are input to a single digital input of said controller.
